(19) United States
(12) Patent Application Publication
(10) Pub. No.: US 2017/0089764 A1
(43) Pub. Date: Mar. 30, 2017

(54) MULTI-REFERENCE CORRELATED DOUBLE SAMPLING DETECTION METHOD AND MICROBOLOMETER USING THE SAME

(71) Applicant: Korea Advanced Institute of Science And Technology, Daejeon (KR)

(72) Inventors: Kwyro LEE, Daejeon (KR); Minsik KIM, Daejeon (KR); Seunghyun PARK, Daejeon (KR)

(73) Assignee: Korea Advanced Institute of Science And Technology, Daejeon (KR)

(21) Appl. No.: 15/274,177

(22) Filed: Sep. 23, 2016

(30) Foreign Application Priority Data
Sep. 24, 2015 (KR) 10-2015-0135675

(51) Int. Cl. G01J 5/34; G01J 5/06

(52) U.S. Cl. CPC G01J 5/34; G01J 5/061; G01J 2005/106

(57) ABSTRACT

Disclosed is a multi-reference correlated double sampling detection method including generating, by a plurality of unit reference cells, reference signals, receiving, by a plurality of unit active cells having absorbed an infrared signal, sensing signals, and detecting a pure infrared signal on a basis of the sensing signals and active cell values processed using the reference signals, wherein the unit reference cells do not react to the infrared signal and are configured of blind cells having identical electrical and thermal characteristics to the unit active cells. Accordingly, a self-heating effect of an active cell may be accurately cancelled out, the method is robust to common noise such as power supply noise, and fixed pattern noise occurring in a sensing circuit and including incoherence between skimming cells may be removed. Furthermore, the method may improve efficiency and greatly reduce complexity of analog and digital correction, and remove a thermo-electro cooler and shutter.

### CROSS-REFERENCE TO RELATED APPLICATION

This application claims priority to Korean Patent Application No. 10-2015-0135675 filed on Sep. 24, 2015 and all the benefits accruing therefrom under 35 U.S.C. §119, the contents of which are incorporated by reference in their entirety.

### BACKGROUND

The present disclosure relates to a multi-reference correlated double sampling detection method in a detection circuit using a microbolometer array and a microbolometer using the same, and more particularly, to a multi-reference correlated double sampling detection method capable of reducing various fixed pattern noises and easily removing a thermoelectric cooler and a shutter, and a microbolometer using the same.

An infrared detector is classified into a light-based detector and a thermal-based detector. The thermal-based detector generates a temperature image of a target object by using a thermal sensor array. In this way, an apparatus for obtaining a temperature image by collecting block body radiation energy radiated from a subject is called a far-infrared thermal imaging system.

The thermal-based detector includes a bolometer, a microbolometer, pyroelectricity, and thermopile. When far-infrared in a prescribed band which is black-body-radiated from an object is collected on the micro-bolometer by a lens, the temperature of the micro-bolometer rises or falls to change electrical resistance of the micro-bolometer. By using this, it becomes possible to image a temperature distribution of a subject remotely by measuring electrical resistance values of active cells provided in microbolometers, that is, a micro-bolometer array.

Since being manufactured by vacuum-packaging pixel arrays of thousands to several hundred thousands, a thermal image sensor using a microbolometer has limitations of very high fixed pattern noise (FPN) as well as low manufacturing yields.

A minimum signal level of a microbolometer is indicated with a noise equivalent temperature difference (NETD), and since this is very smaller (approximately the magnitude of 1/10,000) than the FPN, it is very difficult to simultaneously satisfy a high reactivity and a wide dynamic range. In order to address these limitations, since a very complex test and correction process are necessary, and additional facilities such as a hardware/software element, a thermoelectric cooler, and a shutter are also necessary, it is burdensome in terms of a cost as well as the size and power consumption.

Main FPN sources are approximately as the following.
non-uniformity or incoherence between active cells, skimming cells, and between an active cell and a skimming cell according to a process variation of thermistor resistance, thermal capacity, thermal resistance, or an infrared absorption rate in an active cell and skimming cell
voltage/current variation noise due to a power supply and bias, a threshold voltage of a transistor, or an input offset voltage and current, a current signal integration time, or switching noise, etc., of an operational amplifier
thermistor resistance change according to a temperature change due to heat generated in a substrate, lens, housing, or detecting circuit, etc.
self-heating by the detecting circuit (this is a common limitation of all thermistor thermometers which operate in a principle of measuring a change in electric resistance value according to the temperature change)
1/f noise (has both of two characteristics of FPN and random noise)

When such FPN is generated, the infrared signal is buried with the noise and elaborate analog correction or digital correction, etc., for removing this is inevitable.

The correction for removing the FPN is performed using a reference block body having a constant temperature as a reference signal source. Correction for a remote radiation temperature detected by each active cell is typically performed by measuring two reference black body temperatures, approximating the measured temperatures to a first-order function having two constants, and interpolating or extrapolating the measured values to an actual temperature. Such correction is called two-point correction and the two constants obtained at this point are respectively called a gain and an offset.

However, since an environment in an actual use is very different from that at the time of extracting the correction constant due to a substrate temperature change or a housing temperature change, it is difficult to perform accurate correction in a field use. In order to address the limitation, a thermoelectric cooler and a shutter are used.

However, since the use of the thermoelectric cooler and shutter becomes a main cause of increases in weight, size, power consumption, and price, etc. of an infrared camera, it is necessary to remove the thermoelectric cooler and shutter for mass distribution of the infrared camera and, in particular, for mass distribution of infrared cameras for civilian demands.

### SUMMARY

The present disclosure provides a multi-reference correlated double sampling detection method and a microbolometer using the same capable of removing, at a single stroke, all fixed pattern noises of to non-uniformity or incoherence between an active cell and a skimming cell and between skimming cells, voltage/current variation noises due to a power supply and bias, a threshold voltage of a transistor, or input offset voltage and current, a current signal integration time, or switching noise of an operation amplifier, and a self-heating difference between the active cell and skimming cell from among fixed pattern noise sources which are generated due to signal detection using a difference signal between the active cell and skimming cell, in signal detection using only typical active cells.

The present disclosure also provides a multi-reference correlated double sampling detection method and a microbolometer using the same capable of easily removing a shutter and a thermoelectric cooler.

In accordance with an exemplary embodiment of the present invention, a multi-reference correlated double sampling detection method includes: generating, by a plurality of unit reference cells, reference signals; receiving, by a plurality of unit active cells having absorbed an infrared signal, sensing signals; and detecting a pure infrared signal on a basis of the sensing signals and active cell values processed using the reference signals, wherein the unit reference cells do not react to the infrared signal and are configured of blind cells having identical electrical and thermal characteristics to the unit active cells.

The plurality of unit reference cells may be configured of an n×m array, where n and m are natural numbers.

The active cell value may be a value obtained by calculating an average value of reference output signals output from n unit reference cells present in each column and subtracting the average value from the sensing signals respectively output from unit active cells.

The detecting of the pure infrared signal may be to detect the infrared signal without a shutter by using an active cell value generated by a difference between the unit active cell value with the infrared signal and an average reference cell value without the infrared signal.

The multi-reference correlated double sampling detection method may further comprise using an average value of reference signals output from n unit reference cells present in each column as a reference signal for generating a bias control signal of an active cell and a skimming cell for removing a thermoelectric cooler.

The multi-reference correlated double sampling detection method may further comprise adjusting the bias control signal of the active cell and the skimming cell such that the average value of the reference signals output from n reference cells present in each column has a median value of a power supply voltage.

In accordance with another exemplary embodiment of the present invention, a microbolometer, which senses a remote infrared signal, includes: a plurality of unit active cells configured to absorb an infrared signal to output reference signals; a plurality of unit reference cells configured not to react to the infrared signal, but to have identical electrical and thermal characteristics to the active cells and to output the reference signals; and a skimming cell configured to commonly remove DC components of the sensing signals and the reference signals; wherein an active cell value for sensing a remote infrared signal is generated on a basis of the sensing signals and the reference signals.

The plurality of unit reference cells may be configured of an n×m array, where n and m are natural numbers.

The active cell value may be a value obtained by calculating an average value of the reference signals output from n unit reference cells present in each column and subtracting the average value from the sensing signals respectively output from unit active cells.

A cold cell or a warm cell may be used as the skimming cell.

The unit reference cell may be a blind cell having identical thermal and electrical characteristics to the unit active cell.

The infrared signal may be detected without a shutter by using an active cell value detected from a difference between an average value of reference output signals output from the unit active cells with the infrared signal and an average value of reference output signals output from n unit reference cells present in each column and without the infrared signal.

An average value of reference signals output from n unit reference cells present in each column may be used as a reference signal for generating a bias control signal of an active cell and a skimming cell for removing a thermoelectric cooler.

The bias control signal of the active cell and the skimming cell may be adjusted such that the average value of the reference signals output from n reference cells present in each column has a median value of a power supply voltage.

### BRIEF DESCRIPTION OF THE DRAWINGS

Exemplary embodiments can be understood in more detail from the following description taken in conjunction with the accompanying drawings, in which:

FIG. 1 illustrates sensing and skimming circuits used in a typical microbolometer;

FIG. 2 is a graph showing a change in output voltage signal of a charge transfer impedance amplifier (CTIA) during a sensing time;

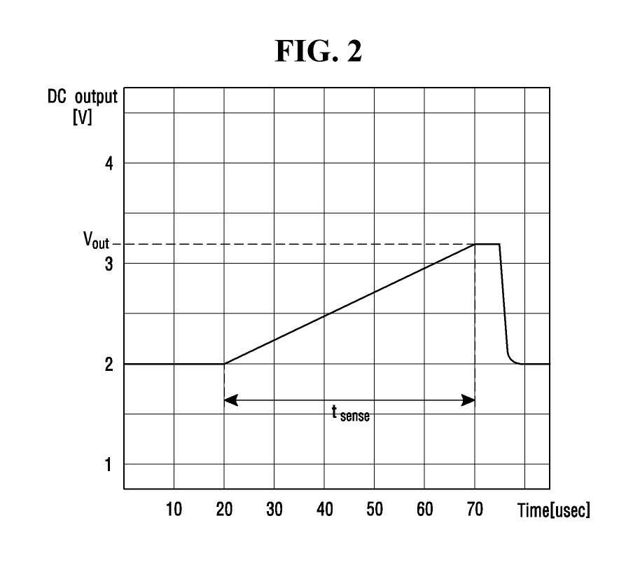

FIGS. 3A to 3D are views for explaining analog and digital correction to remove fixed pattern noise;

FIGS. 4A to 4D illustrate frequency distributions and correction methods for various active cell and reference cell detection values with respect to graphs shown in FIGS. 3A to 3D at a specific substrate temperature Tsub=Tsub2, where Vo,ref is an average value for a plurality of unit reference cell detection values; and

FIG. 5 is a circuit diagram of a microbolometer according to the present disclosure.

### DETAILED DESCRIPTION OF EMBODIMENTS

Detailed description of the present invention will be described below with reference to the accompanying drawings illustrating specific embodiments of the present disclosure. With respect to specific embodiments illustrated in the drawings, a description will be provided in detail so that those having ordinary knowledge in the technical field to which the present disclosure pertains can easily practice the present disclosure. Other embodiments besides specific embodiments are different from each other but need not be mutually exclusive. In addition, it should be understood that the detailed description below is rather than those that try to take as a limiting sense if it is explained properly.

A detailed description about specific embodiments illustrated in the accompanying drawings is to be read in association with the accompanying drawings, which are considered as a part of the entire description. Referring to direction or directivity is merely for the purpose of convenience of description and is not intended to limit the scope of the present disclosure.

In detail, directional terms such as “bottom, top, horizontal, vertical, upper, lower, upward, or downward” or derivatives thereof (for example, “horizontally, downwardly, upwardly, etc.) should be understood with reference to all the drawings and related description. In particular, such relative terms are merely for the purposed of convenience of description, and therefore, a device of the present disclosure is not required to be configured or operate in a specific direction.

In addition, unless otherwise indicated, terms, which represents mutual coupling relationship, such as “mount, attached, connected, or mutually connected”, may mean a state where individual configurations are directly or indirectly attached, connected, or fixed. Therefore the terms should be understood as terms encompassing an unmovable state as well as a movably attached, connected, or fixed state.

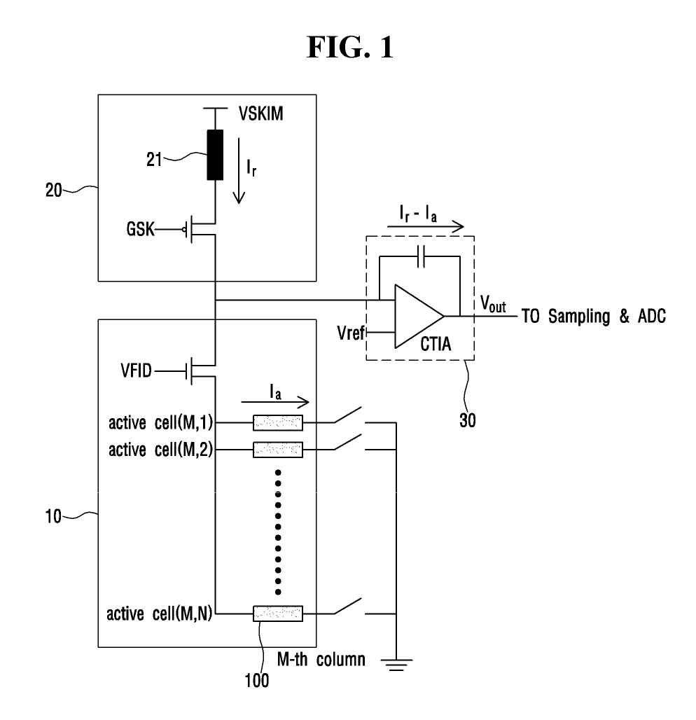

FIG. 1 illustrates a skimming circuit used in a typical microbolometer. A microbolometer according to an embodiment of the present disclosure uses a skimming circuit for removing an unnecessary DC signal in order to satisfy a high sensitivity and wide dynamic range. As illustrated in FIG. 1, the skimming circuit integrates, by using a charge transfer impedance amplifier (CTIA) 30, a different between a current flowing through a sensing circuit 10 configured of active cells 100 and a current flowing through a skimming circuit 20 configured of skimming cells 21, and then obtains an output voltage signal Vₒᵤₜ.

In FIG. 1, the difference Iᵣ−Iₐ between the current Iₐ of the sensing circuit 10, which varies according to a remote infrared signal, and a skimming current Iᵣ flowing through the skimming circuit 20 is delivered to the CTIA 30. At this point, the skimming current Iᵣ flowing through the skimming circuit 20 is irrelative to the remote infrared signal and is shared by all the active cells 100 connected to an identical column.

The output voltage signal Vₒᵤₜ output from the CTIA 30 in FIG. 1 gradually rises from an initial voltage during a sensing time Tₛₑₙₛₑ when infrared detection is performed, becomes maximum at a time when the integration is finished, and then is discharged to the initial voltage. Here, the output voltage signal Vₒᵤₜ may be calculated by the following Equation (1).

$${V}_{out} = {V}_{BUS} - \frac{1}{{C}_{INT}} {\int }_{0}^{{t}_{sense}} ( {I}_{r} - {I}_{a} ) d t \qquad ( 1 )$$

where, V_{BUS} denotes a voltage value input to a positive terminal of an OP AMP provided in CTIA 30, C_{INT} denotes capacitance of a capacitor provided to the CTIA 30, tₛₑₙₛₑ denotes a sensing time, Iₐ denotes a current flowing through the sensing circuit 10 that reacts to an infrared signal, and Iᵣ denotes a current flowing through the skimming circuit 20 that does not react to the infrared signal and has a function for adjusting a DC component of Vₒᵤₜ, namely, an offset. Consequently, a gain of the sensing circuit 10 is adjusted to VFID and the DC component of Vₒᵤₜ, namely, the offset is adjusted to GSK-VSKIM. As the skimming cell 21, a cold cell that does not have a self-heating effect or a warm cell that is capable of canceling self-heating may be typically used.

The cold cell is a reference cell in which there is little self-heating and has thermal incoherence with an active cell. When a warm cell is used, such a limitation may be addressed. A warm cell is manufactured through an identical process to that of the active cell and has an identical body part to the active cell and identical electrical and thermal flows. The warm cell is a kind of a skimming cell made such that the thermal conductivity is arbitrarily adjustable by providing an additional heat transfer path to a leg part. When the warm cell is used, an average temperature rise of a self-heated active cell during a sensing time may be cancelled out by a temperature rise of the warm cell in a normal state. Such a warm cell of which self-heating is cancelable has the following characteristics.

(1) Electrical coherence with the active cell 100 is excellent in an electric resistance value and current flow.

(2) Thermal coherence with the active cell 100 is excellent in a heat flow inside a body part.

(3) 1/f noise is small and reactivity for infrared light is low.

(4) A self-heating effect with the active cell 100 may be cancelled by adjusting the thermal conductivity in a prescribed range to arbitrarily adjust a self-heating amount.

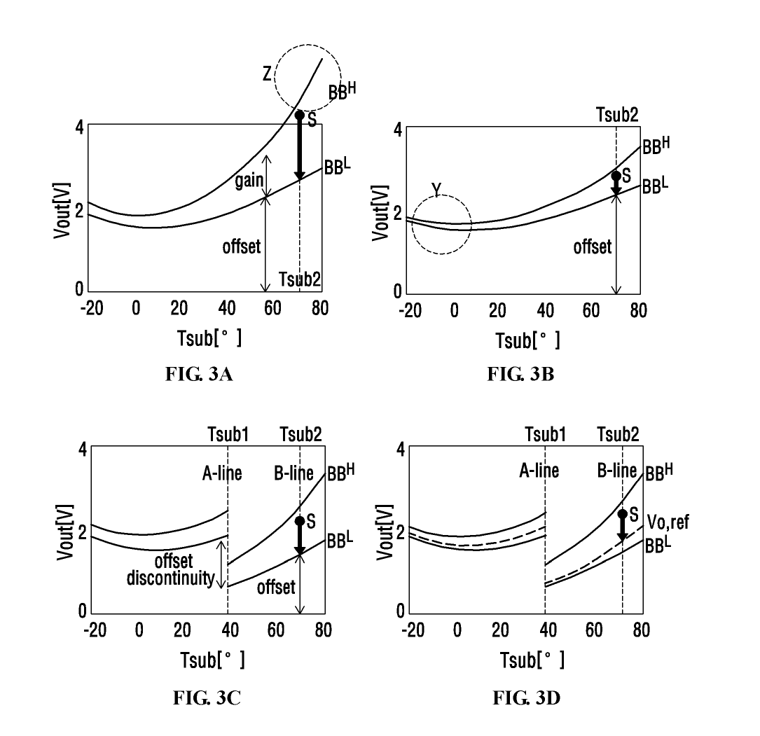

FIG. 3A illustrates output characteristics of the sensing circuit 10 illustrated in FIG. 1, and FIG. 3B illustrates a method for preventing analog saturation by adjusting VFID to reduce the gain.

In addition, FIGS. 3C and 3D are views for explaining a case where an output DC is dragged down by changing a GSK bias voltage at a substrate temperature higher than Tsub1 in order to address degradation of reactivity occurring in FIG. 3B. Each graph will be described in detail below.

Firstly, FIG. 3A shows a typical output characteristic of the sensing circuit 10 illustrated in FIG. 1. BB^{H} and BB^{L} respectively denote two black body reference temperatures used for extracting correction parameters, and a point indicated with S represents an output value of a specific active cell, which is obtained in image detection. Here, dependence of an offset for each active cell and a gain value on the substrate temperature may be approximated by interpolating or extrapolating BB^{H} and BB^{L} curves.

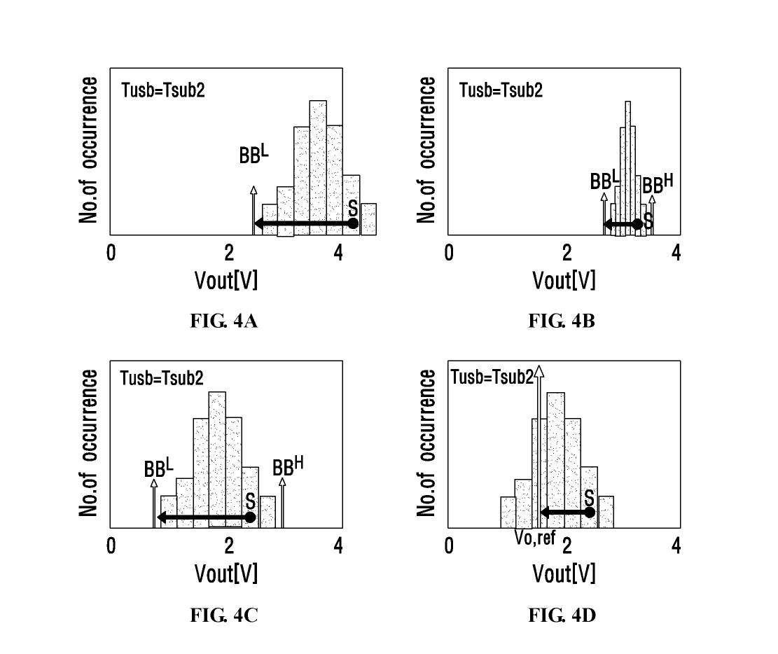

A correction procedure at the time of obtaining a temperature signal will be as the following. In FIG. 3A, when a detection value indicated with S point is measured at a specific substrate temperature of Tsub2, a temperature may be inversely calculated by subtracting an offset value corresponding to BB^{L} from the detection value and linearly interpolating the subtracted value between BB^{L} and BB^{H}. This is indicated with arrows in FIGS. 3A to 3C and FIGS. 4A to 4C.

As the output characteristics of FIG. 3A, a maximum dynamic range may be achieved at Vₒᵤₜ=V_{BUS}=VSKIM/2, when there is not an infrared signal and Iᵣ=Iₐ. However, in reality, due to various FPNs caused by the above-described process variation, etc., a Vₒᵤₜ value of each active cell has wide dispersion and therefore it is very difficult to simultaneously obtain a wide dynamic range and high reactivity.

At this point, while a temperature rise in the active cell 100 occurs during the sensing time Tₛₑₙₛₑ due to so-called self-heating that a temperature rises by Joule heating due to power given by multiplication of a voltage applied to read a thermistor resistance value by a current flowing at this point, a cold cell used as a skimming cell does not have self-heating to cause thermal incoherence between both cells and subsequently causes electrical incoherence. In other words, during the sensing time, an average temperature of the active cell 100 becomes greatly differed from an average temperature of a cold cell used as a skimming cell 21 to cause the incoherence due to a difference in self-heating between the two cells, and the FPN is caused thereby.

Such FPN causes the following limitations.

1. As illustrated in FIG. 3A, when FPN is excessively large, a DC component is not sufficiently removed by a skimming circuit and a meaningful signal is not obtained since an output Vₒᵤₜ of the sensing 10 is saturated to a maximum or minimum output level. This is called analog saturation phenomenon and corresponds to a Z region indicated with a circuit (dotted line) in FIG. 3A. This is a most serious chip level limitation for the FPN and in order to address the limitation, it is necessary to adjust an analog bias (VFID and/or GSK of FIG. 1) commonly applied to the entire pixels or to maintain a constant substrate temperature by means of a thermoelectric cooler, etc. This is called analog correction and the purpose thereof is to control a dynamic range and reactivity, while the sensing circuit 10 is not allowed to be saturated. FIG. 3B illustrates a method for reducing a gain by using VFID to allow the sensing circuit 10 not to be saturated. However, this method has a limitation in that reactivity for an infrared signal gets lower in a low substrate temperature region, which corresponds to a region indicated with a circle (dotted line) on a Y portion.

2. FIG. 3C illustrates a method for lowering only a DC component of an output voltage through skimming to make an output distribution be within the dynamic range of the CTIA, while reactivity is as shown in FIG. 3A. The method is performed by adjusting a skimming amount with a GSK voltage. At this point, VFID is not changed, so that there is no change in reactivity and only an offset is independently adjustable through GSK adjustment. However, this method has the following limitations. First, when interpolation values or extrapolation values for an offset are different in a lower side and a higher side on the basis of Tsub1 (indicated with A-line) in FIG. 3C, very large discontinuities of the infrared signal and temperature signal may occur. Second, while temperature compensation is a function that is very sensitive to the substrate temperature, accuracy of a temperature sensing sensor is very low such that it is difficult to apply a precise control algorithm thereto.

3. Although not saturated, straight stripes of a certain grey level are generated in an arbitrary column or row. This is common FPN for a certain column or row and is mainly addressed with digital correction. In addition, the FPN for each active cell is also addressed with digital correction. This is called non-uniformity correction (NUC) and is to remove various types of FPN and recover an accurate pixel signal. Typically such correction is performed using a reference thermal image obtained by using several black bodies at several reference substrate temperatures, but the correction is not easy since the sensing circuit output Vₒᵤₜ becomes a very complicated function of a target infrared signal image, a substrate temperature, heat irrelative to an infrared signal radiated from a lens housing, and non-uniformity and self-heating of each pixel, etc. Such a multi-dimensional and digital NUC for each active cell takes much time to extract parameters and requires lots of image correction memory and operation hardware/software, which causes a cost increase.

In order to address such limitations, a thermoelectric cooler and a shutter are typically used. The thermoelectric cooler is advantageous in that correction complexity may be greatly reduced by maintaining a substrate temperature constant to remove dependence of the offset and gain on the substrate temperature. However, since the use of the thermoelectric cooler is a main cause of increases in size, weight, power consumption, and production cost, it is better to remove it.

In addition, when the shutter is used, only a pure infrared signal may be detected by subtracting a detection value of an active cell without an infrared signal in a shuttered state from a detection value of the active cell obtained in a state where the shutter is open. Accordingly, in this case, since only gain correction is required and offset correction is not necessary, correction complexity may be greatly reduced. However, similar to the thermoelectric cooler, the use of the shutter increases the weight, volume, power consumption and production cost of a camera, and causes a critical limitation that a video freezes at the time of shutter operation.

The present disclosure provides a micro-bolometer array of a structure different from a typical one and a multi-reference correlated double sampling detection method.

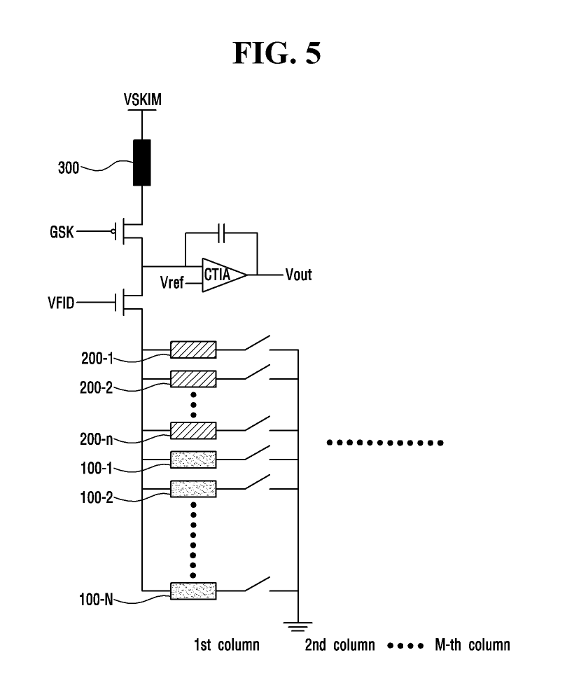

FIG. 5 illustrates a configuration of a micro-bolometer according to the present disclosure. A basic configuration is the same as that of FIG. 1, but a plurality of reference cells 200-1, 200-2, . . . , and 200-n are provided to each column in which a plurality of unit active cells 100-1, 100-2, . . . , and 100-N are disposed.

The active cells 100-1, 100-2, . . . , and 100-N are infrared sensing devices and have very large thermal resistance values in order to absorb much infrared light and increase sensitivity, thereby producing much self-heating. In contrast, since a cold cell used as the skimming cell 300 reflects infrared and has very low thermal resistance value, it rarely has a self-heating effect. Accordingly, electrical incoherence occurs therebetween and a DC offset, which is irrelative to the infrared signal, is greatly caused in Vₒᵤₜ.

A multi-reference correlated double sampling detection method and a micro-bolometer using the same uses, as the unit reference cells 200-1, 200-2, . . . , and 200-n, blind cells having identical characteristics and/or structure to the unit active cells except for reflecting infrared light. The blind cell has identical thermal and electrical characteristics to the active cells 100-1, 100-2, . . . , and 100-N except for reflecting the infrared light. In other words, flows and magnitudes of currents and heats flowing through respective cells may be the same.

There is a microbolometer of a Wheatstone bridge structure in which a reference voltage signal applied to one reference cell is shared by various active cells using the only one reference cell, but this microbolometer has a limitation of increase in FPN and random noise according to various types of resistors and incoherence between voltage amplifiers.

There is another microbolometer in which a reference signal is generated using only one blind cell as a reference cell and the reference signal is copied in a circuit form to be shared by the active cells connected to an identical column, which is not practical in that there occurs additional noise and incoherence in a current copy process.

As illustrated in FIG. 5, a micobolometer according to the present disclosure is provided with a plurality of unit reference cells 200-1, 200-2, . . . , 200-n for each column. Here, the skimming cell 300, as a dummy cell commonly connected to an active cell or a reference cell and adjusting an output DC level, is shared by all the reference cells and active cells 100-1, 100-2, . . . , and 100-N connected to an identical column.

Firstly, a sequence of reading output signals of the active cells 100 and the reference cells 200 provided in a first column is as the following.

First, an output signal of the unit reference cell 200-1 present in a first row is read, and then an output signal of the unit reference cell 200-2 present in a second row is read. In this way, sequential reading is performed to an output signal of the unit reference cell 200-n present in an n-th row.

Then, a sensing current signal of the active cell 100-1 present in the first row is read, and then a sensing current signal of the active cell 100-2 present in the second row is read. In this way, sequential reading is performed to a sensing current signal of the active cell 100-N present in an N-th row.

At this point, an average value of the output signals read from n unit reference cells 200-1, 200-2, . . . , and 200-n is calculated to be adopted as a reference cell value, the reference cell value is subtracted from the signals read from N active cells 100-1, 100-2, . . . , and 100-N, and then the subtracted values are used as respective active cell values for detecting remote infrared light. Here, n and N are natural numbers of 1 or greater.

The above-described output value determining process for the active cells 100-1, 100-2, . . . , and 100-N is also identically applied to the second to M-th columns where M is a natural number of 1 or greater.

In this way, detecting an infrared signal by an average detection value difference between active cells and various reference cells is called multi-reference correlated double sampling detection method and provides various advantages.

Firstly, various types of FPN may be removed. In other words, there is an effect capable of removing incoherence occurring between skimming cells used for each column or incoherence between sensing circuits such as the CTIA. In addition, power noise, which varies very slowly without a large change between detections of a reference cell and an active cell, may be removed and, in particular, since blind cells used as the unit reference cells 200-1, 200-2, . . . , and 200-n and active cells go through identical heating and cooling processes, a self-heating effect may be cancelled.

Next, a shutter may be removed. As described above, in a typical shutterless method as shown in FIG. 3C, at the time of extracting correction parameters, an offset voltage value indicated as BB^{L} is required to be measured with a function of a very elaborate substrate temperature Tsub, and to this end, a temperature Tsub at the time of correction is also required to be measured very precisely. However, in reality, it is very difficult to measure temperature of Tsub precisely and when a value of VSK is changed at a specific temperature in order to adjust a dynamic range, elaborate correction becomes very difficult due to discontinuity of an offset value. In contrast, according to the present disclosure as illustrated in FIGS. 3D and 4D, since a difference between an output value (a point indicated as S) of an active cell with an infrared signal and an output value (indicated with Vo,ref) of a reference cell without an infrared signal is used as a detection value, it is not necessary to measure, store, and interpolate an offset curve indicated as BB^{L}, which is obtained at the time of extracting a correction parameter. In this aspect, the present disclosure has an almost same effect as the use of shutter.

Here, a multi-reference correlated double sampling technique, which does not use one reference cell value but averages measurement values of various identical unit reference cells 200-1, 200-2, . . . , and 200-n to use as one reference cell value, may reduce the magnitude of random noise such as thermal noise and 1/f noise as well as the magnitude of FPN to 1/sqrt(n). For example, when 16 reference cells are used, the FPN and random noise are respectively reduced to ¼ and an NETD is improved that much. When infrared light is detected using a typical shutter, FPN is cancelled but random noise such as thermal noise is not removed in a process in which a shutter is opened for each active cell, infrared light is detected, and then a detection signal of an identical active cell in a state where the shutter is closed is subtracted from the detection signal of the infrared light. According to the present disclosure, an NETD improvement effect of maximum sqrt(2)=1.4 times greater than that of the shuttered case may be obtained.

In other words, an entire chip average value of reference signals output from n×m unit reference cells present in each chip may be used as a reference signal for generating a bias control signal for an active cell and a skimming cell for removing a thermoelectric cooler. FIG. 4A illustrates a state where several active cell outputs are analog-saturated, and FIG. 4C illustrates a case where GSK is properly adjusted such that an average output value is positioned at a median value of VSKIM to have a maximum dynamic range.

Typically, an average of output signal is obtained and the average is used as a control signal for adjusting GSK. However, since an output infrared thermal image signal varies very dynamically according to a time, it is not proper to use the output infrared thermal image signal as a reference signal for generating an optimal GSK control signal. However, since an average reference cell detection value for the entire chip, which is obtained in the present disclosure, depends only on a substrate temperature and is irrelative to an infrared image signal, it is very proper to use the average reference cell detection value as a stable reference signal for a GSK control.

In addition, a process for adjusting a bias control signal of a skimming cell may be further included such that an entire average chip value of reference signals output from n×m unit reference cells 200-1, 200-2, . . . , and 200-n has a median value of a power supply voltage. FIG. 4D illustrates a method for adjusting GSK such that an average reference cell output value becomes Vo,ref in order to allow an average of output detection signals is positioned at a center of VSKIM.

According to a multi-reference correlated double sampling detection method and a microbolometer using the same according to the above-described configuration, the followings may be achieved.

1. Since only a difference between an active cell output signal for an infrared light input through a lens and a reference cell output signal without an infrared signal is detected, FPN may be canceled out which is generated by various types of incoherence, which is generated in a signal obtaining circuit and includes incoherence generated in each column by skimming cells.

2. Since a blind cell is used as a unit reference cell, self-heating and cooling processes between a unit active cell and a unit reference cell may be made identical, a self-heating effect between the two cells may be accurately canceled out.

3. Since a signal difference between an active cell and a reference cell, it is robust to common noise such as power supply noise.

4. FPN, which is commonly generated in a detection circuit for each column including skimming cells, is removed and only an infrared signal may be efficiently detected by subtracting an output signal of a reference cell without the infrared signal from an output signal of an active cell with the infrared signal. At this point, new FPN and random noise due to heat and 1/f noise may be generated by a process variation of the unit reference cell, but the new FPN and random noise may be greatly reduced by averaging output signal values of a plurality of reference cells.

5. The average value of the reference cell output signals may be used as a stable reference signal for a bias control for VFID, GSK, and Vref of FIG. 1. Accordingly, a gain control using VFID and a DC offset control using GSK or Vref may be independently performed. This may remarkably reduce complexity of analog correction and digital correction to efficiently improve a correction efficiency and help to remove a thermoelectric cooler.

6. A shutter may be easily removed by removing a DC offset signal which is irrelative to a signal through a difference between an active cell value with an infrared signal and a reference cell value without the infrared signal and by using a double correlated sampling method capable of easily finding a pure infrared signal. In particular, random noise as well as FPN of the reference cell itself may be greatly reduced by averaging various unit reference cell values. As a result, a noise equivalent temperature difference (NETD) smaller than that in a shutter use may be obtained.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A multi-reference correlated double sampling detection method comprising:
generating, by a plurality of unit reference cells, reference signals;
receiving, by a plurality of unit active cells having absorbed an infrared signal, sensing signals; and
detecting a pure infrared signal on a basis of the sensing signals and active cell values processed using the reference signals,
wherein the unit reference cells do not react to the infrared signal and are configured of blind cells having identical electrical and thermal characteristics to the unit active cells.

2. The multi-reference correlated double sampling detection method of claim 1, wherein the plurality of unit reference cells are configured of an n×m array, where n and m are natural numbers.

3. The multi-reference correlated double sampling detection method of claim 2, wherein the active cell value is a value obtained by calculating an average value of reference output signals output from n unit reference cells present in each column and subtracting the average value from the sensing signals respectively output from unit active cells.

4. The multi-reference correlated double sampling detection method of claim 3, wherein the detecting of the pure infrared signal is to detect the infrared signal without a shutter by using an active cell value generated by a difference between the unit active cell value with the infrared signal and an average reference cell value without the infrared signal.

5. The multi-reference correlated double sampling detection method of claim 1, further comprising:
using an average value of reference signals output from n unit reference cells present in each column as a reference signal for generating a bias control signal of an active cell and a skimming cell for removing a thermoelectric cooler.

6. The multi-reference correlated double sampling detection method of claim 5, further comprising: adjusting the bias control signal of the active cell and the skimming cell such that the average value of the reference signals output from n reference cells present in each column has a median value of a power supply voltage.

7. A microbolometer, which senses a remote infrared signal, comprising:
a plurality of unit active cells configured to absorb an infrared signal to output reference signals;
a plurality of unit reference cells configured not to react to the infrared signal, but to have identical electrical and thermal characteristics to the active cells and to output the reference signals; and
a skimming cell configured to commonly remove DC components of the sensing signals and the reference signals;
wherein an active cell value for sensing a remote infrared signal is generated on a basis of the sensing signals and the reference signals.

8. The microbolometer of claim 7, wherein the plurality of unit reference cells are configured of an n×m array, where n and m are natural numbers.

9. The microbolometer of claim 8, wherein the active cell value is a value obtained by calculating an average value of the reference signals output from n unit reference cells present in each column and subtracting the average value from the sensing signals respectively output from unit active cells.

10. The microbolometer of claim 7, wherein a cold cell or a warm cell is used as the skimming cell.

11. The microbolometer of claim 7, wherein the unit reference cell is a blind cell having identical thermal and electrical characteristics to the unit active cell.

12. The microbolometer of claim 7, wherein the infrared signal is detected without a shutter by using an active cell value detected from a difference between an average value of reference output signals output from the unit active cells with the infrared signal and an average value of reference output signals output from n unit reference cells present in each column and without the infrared signal.

13. The microbolometer of claim 7, wherein an average value of reference signals output from n unit reference cells present in each column is used as a reference signal for generating a bias control signal of an active cell and a skimming cell for removing a thermoelectric cooler.

14. The microbolometer of claim 7, wherein the bias control signal of the active cell and the skimming cell is adjusted such that the average value of the reference signals output from n reference cells present in each column has a median value of a power supply voltage.
